(19) United States
(12) Patent Application Publication
(10) Pub. No.: US 2019/0283205 A1
(43) Pub. Date: Sep. 19, 2019

(54) POLISHING ROLL

(71) Applicant: NITTA HAAS INCORPORATED, Osaka-shi, Osaka (JP)

(72) Inventors: Yoshitaka MORIOKA, Kyotanabe-shi (JP); Kazunori ITO, Kyotanabe-shi (JP); Keng LIN, Kyotanabe-shi (JP); Jia-Wen TSAI, Kyotanabe-shi (JP)

(73) Assignee: NITTA HAAS INCORPORATED, Osaka-shi, Osaka (JP)

(21) Appl. No.: 16/346,058

(22) PCT Filed: Oct. 30, 2017
(86) PCT No.: PCT/JP2017/039074

§ 371 Date: Apr. 29, 2019

(30) Foreign Application Priority Data
Oct. 31, 2016 (JP) 2016-213160

(51) Int. Cl. B24B 37/22; B24B 37/24; B24D 9/04; B24D 3/28; B24D 11/06; B32B 1/08; B32B 3/30; B32B 5/18

(52) U.S. Cl. CPC B24B 37/22; B24B 37/24; B24D 9/04; B24D 3/28; B24B 7/24; B32B 1/08; B32B 3/30; B32B 5/18; B24D 11/06

(57) ABSTRACT

The present invention provides a polishing roll capable of, for example, realizing three-dimensional polishing of hard materials such as sapphire glass at a high removal amount. The polishing roll is a cylindrical polishing roll capable of rotating about a central axis, characterized in that the polishing roll includes a core part serving as a central axis to which torque is applied, an intermediate part having a cross-section concentric with the core part, and a polishing part disposed on the outer peripheral surface of the intermediate part, and the intermediate part is made of a cushion material that is softer than the polishing part.

### TECHNICAL FIELD

The present invention relates to a polishing roll used in a polishing device of chemical mechanical polishing (CMP) and the like.

### BACKGROUND ART

Polishing devices that chemically and mechanically polish a wafer surface (to be referred to as “CMP”) are being used practically in order to planarize semiconductor wafers in the production process of semiconductor chips. In typical CMP devices, an upper platen retaining a wafer is placed on a lower platen installed with a polishing pad and the wafer surface is polished by moving the polishing pad relative to the wafer while supplying a slurry (polishing agent obtained by mixing a solvent and an abrasive) there between and applying pressure to the wafer and polishing pad (see, for example, Patent Document 1).

However, in the case of the surface contact type polishing method described above, it is difficult to control the distribution of pressure of the polishing surface contacted by the polishing pad to a constant distribution over the entire wafer. For example, if one end of the polishing pad becomes worn down resulting in a loss of surface uniformity, undulation or warping may end up occurring throughout the entire wafer surface. In particular, this problem becomes remarkably serious when pad size is increased in order to polish large-diameter wafers.

On the other hand, a line contact type of polishing roll is also known in which a wafer surface is polished by moving a rotating polishing roll relative thereto and contacting the polishing roll with the wafer while applying pressure by employing a polishing pad in the form of a rotating roll used to planarize the entire surface and peripheral edges (beveled surface) of large-diameter wafers (see, for example, Patent Documents 2, 3 and 4).

In the development of next-generation smartphones, the use of sapphire glass is being examined for use as a material of the transparent panel of the touch screen serving as the operating display. In order to realize a design that imparts an aesthetically appealing and soft feel required by smartphones as well as smooth operation of the touch screen, processing technology is required that enables not only planarization of the upper surface and the side surface of the sapphire glass, but also continuous and high-speed spline (round cut) polishing of the edges.

### PRIOR ART DOCUMENTS

### Patent Documents

Patent Document 1: JP 2008-49448 A
Patent Document 2: JP H9-50975 A
Patent Document 3: JP H10-100063 A
Patent Document 4: JP 2004-63900 A

### DISCLOSURE OF THE INVENTION

### Problems to be Solved by the Invention

However, the polishing roll employed in the aforementioned CMP employs a technology that was developed for planar polishing of the surfaces of semiconductor wafers. Consequently, the polishing roll employed in CMP was unable to be applied as is to three-dimensional polishing of hard glass materials used in the aforementioned next-generation smartphones and the like requiring a high level of polishability. For example, when a polishing pad made of a hard material is employed to realize a high removal amount, the polishing roll makes line contact with the workpiece (polished object) resulting in the formation of fine undulations and line marks in the polishing surface.

With the foregoing in view, an object of the present invention is to provide a polishing roll capable of, for example, realizing three-dimensional polishing of hard materials such as sapphire glass at a high removal amount.

### Means for Solving the Problems

In order to solve the aforementioned problems, the present invention provides a cylindrical polishing roll capable of rotating about a central axis, characterized in that the polishing roll includes a core part serving as a central axis to which torque is applied, an intermediate part having a cross-section concentric with the core part, and a polishing part disposed on the outer peripheral surface of the intermediate part, and the intermediate part is made of a cushion material that is softer than the polishing part.

The polishing roll is preferably such that the polishing part is a nonwoven fabric or a nonwoven fabric impregnated with a resin. The polishing roll may also be such that the polishing part is a foamed body or foamed body impregnated with a resin. The resin preferably contains polyurethane.

The polishing roll is preferably such that the polishing part is impregnated with a ceria (cerium oxide) and/or silica (silicon oxide) abrasive.

The polishing roll is preferably such that the polishing part has grooves in the surface thereof.

The polishing roll is preferably such that the grooves include linear parallel grooves and the angle of the grooves relative to the direction of the axis of rotation of the polishing roll is 0 degrees to 90 degrees.

The polishing roll is preferably such that the grooves are lattice-like grooves.

The polishing roll is preferably such that the intermediate part is composed of a foamed body. The foamed body is preferably sponge-like polyurethane foam.

The polishing roll is preferably such that the intermediate part is composed of an elastomer.

The polishing roll is preferably such that the polishing part is a polishing sheet adhered to the outer peripheral surface of the intermediate part.

The polishing roll is preferably such that the polishing sheet has the shape of a parallelogram.

The polishing roll is preferably such that both mutually joining ends of the polishing sheet wound around the intermediate part are stitched.

The polishing roll is preferably such that both mutually joined ends of the polishing sheet wound around the intermediate part form a line on an incline relative to the circumferential direction. The seam allowance (abutting surfaces) of both mutually joining edges of the polishing sheet wound around the intermediate part is preferably tapered.

The polishing roll is preferably such that the core part is composed of a metal shaft part serving as the central axis, and a hollow cylindrical part in the shape of a hollow cylinder for disposing the metal shaft part in the interior thereof that has a structure enabling removal from the metal shaft part.

The polishing roll is preferably such that the hollow cylindrical part has a structure adhered to the intermediate part.

### Effects of the Invention

According to the polishing roll according to the present invention, a high removal amount can be achieved when polishing a hard material such as sapphire glass. In addition, the polishing roll is able to realize three-dimensional polishing in the manner of round cut polishing that follows not only the planarity of the upper surface and sides of the polished object, but also arbitrary spline surfaces in the edges thereof.

### BRIEF DESCRIPTION OF THE DRAWINGS

FIG. 1 is a perspective view exemplifying a polishing roll.

FIG. 2 is a side view for explaining a method for polishing with a polishing roll.

FIG. 3 is a drawing exemplifying a stitched part of a polishing sheet.

FIG. 4 is a drawing exemplifying a polishing roll according to another embodiment.

FIG. 5 is drawing showing a polishing roll according to an example in which the polishing sheet is stitched.

FIG. 6 is a side view showing a polishing method according to an example.

FIG. 7 is a graph indicating the results of polishing with a polishing roll according to an example.

FIG. 8 is an overhead view exemplifying a polishing roll.

FIG. 9 is a schematic diagram of one example of the shape of grooves of section A of FIG. 8 in the case of disposing the grooves on the surface of a polishing sheet.

FIG. 10 is a schematic diagram of one example of the shape of grooves of section A of FIG. 8 in the case of disposing the grooves on the surface of a polishing sheet.

FIG. 11 is a schematic diagram of one example of the shape of grooves of section A of FIG. 8 in the case of disposing the grooves on the surface of a polishing sheet.

FIG. 12 is a schematic side view of a polishing roll of an example using a core part of a different aspect.

FIG. 13 is a schematic front view of a metal shaft part of an example using a core part of a different aspect.

FIG. 14 is a schematic side view of an intermediate part and a hollow cylindrical part 11b of an example using a core part of a different aspect.

FIG. 15 is a schematic diagram showing the state immediately prior to a polishing sheet in the shape of a parallelogram winding around a roll having an intermediate part.

FIG. 16 is a schematic diagram showing the state of polishing sheet in the shape of a parallelogram wound around a roll having an intermediate part.

FIG. 17 is a schematic diagram showing an example of a polishing roll in which a band-shaped polishing sheet is wound around a roll having an intermediate part.

FIG. 18 is a schematic cross-sectional view of an example of a polishing sheet having grooves.

FIG. 19 is a schematic cross-sectional view of first edge and a second edge that have been processed in an example of a polishing sheet having grooves.

FIG. 20 is a schematic cross-sectional view showing the state in which a first edge and a second edge have been adhered in an example of a polishing sheet having grooves.

FIG. 21 is a schematic cross-sectional view showing the state in which machined parts of a second edge have been machined in an example of a polishing sheet having grooves.

### MODE FOR CARRYING OUT THE INVENTION

The following provides an explanation of preferred embodiments of the polishing roll according to the present invention. FIG. 1 is a perspective view showing a polishing roll 10 according to one embodiment of the present invention. The appearance of the polishing roll 10 roughly has a cylindrical shape. A core part 11 to which torque is applied passes through the center of the polishing roll 10. The polishing roll 10 is able to rotate using this core part 11 as an axis of rotation.

The core part 11 is preferably composed of a hard material having mechanical rigidity that does not allow the occurrence of bending deformation and the like caused by pressing force during polishing use, and is formed with a material having corrosion resistance to slurry and the like. The core part 11 can be formed from, for example, metal such as stainless steel, glass fiber plastic or fiber-reinforced plastic. In addition, although FIG. 1 shows the core part 11 as a columnar shaft, it may also be a hollow cylindrical shaft.

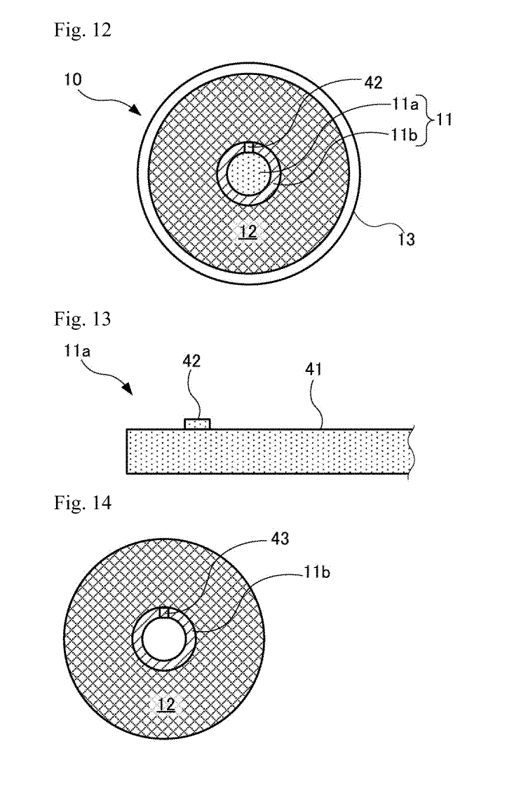

FIG. 12 shows a schematic side view of one example of the polishing roll 10 that uses the core part 11 of a different aspect. In the example shown in FIG. 12, the core part 11 contains a metal shaft part 11a and a hollow cylindrical part 11b. In this case, the hollow cylindrical part 11b is in the shape of a hollow cylinder for disposing the metal shaft part 11a there within, and can have a structure that enables removal from the metal shaft part 11a. In addition, as shown in FIG. 14, the hollow cylindrical part 11b can have a structure adhered to an intermediate part 12. As a result of the hollow cylindrical part 11b having a structure enabling removal from the metal shaft part 11a, the hollow cylindrical part 11b (along with the intermediate part 12 and a polishing part 13) can be removed from the metal shaft part 11a when the polishing roll 10 has deteriorated due to polishing. As a result, the metal shaft part 11 can be reused.

FIG. 13 shows a schematic frontal view of the metal shaft part 11a. The metal shaft part 11a can contain a shaft body 41 and a key 42. As shown in FIGS. 12 and 14, the key 42 is able to transfer rotation of the metal shaft part 11a to the hollow cylindrical part 11b (along with the intermediate part 12 and the polishing part 13) during polishing by the polishing roll 10 as a result of engaging with a key groove 43 of the hollow cylindrical part 11b. The key 42 is preferably removably attached to the shaft body 41 by, for example, being screwed thereto. Although FIG. 13 shows the state in which the key 42 is disposed near one end of the shaft body 41, the keys 42 are preferably disposed near both ends of the shaft body 41.

The metal shaft part 11a is preferably composed of a material that has mechanical rigidity such as a metal such as stainless steel, glass fiber plastic or fiber-reinforced plastic. On the other hand, the hollow cylindrical part 11b can be formed with an arbitrary material having mechanical rigidity. The hollow cylindrical part 11b is preferably formed from a resin material from the viewpoints of ease of forming and processing into a hollow cylindrical shape and adhesiveness with the intermediate part 12.

As shown in FIG. 1, the cylindrical polishing roll 10 comprises the intermediate part 12, having a concentric cross-section centering about the core part 11, and the polishing part 13 disposed on the outer peripheral surface of the intermediate part 12.

The intermediate part 12 is formed with a cushion material that is softer than the polishing part 13. Here, although the cushion material of the intermediate part 12 is resistant to compressive deformation and there are no particular limitations thereon provided the material generates repulsion when compressed, it is preferably, for example, a foamed body. Examples of foamed bodies that can be employed include sponge-like polyurethane foam, polyethylene foam, polypropylene foam, polyester foam and foam rubber, and among these, polyurethane foam is preferable.

In addition, the intermediate body 12 can also be formed with an elastomer (such as an elastic polymer) in addition to a foamed body.

Furthermore, the term “soft” means that a material has a comparatively low degree of hardness. Hardness can be represented with the Asker-C value (hardness measured with an Asker C Rubber Hardness Meter). Furthermore, Asker-C and Shore C refer to the same hardness.

There are no particular limitations on the method used to produce the intermediate part 12. For example, the intermediate part 12 can be obtained in a cylindrical shape by combining a plurality of soft cushion materials of prescribed shapes. In addition, the cylindrical intermediate part 12 can be produced by molding by filling raw materials of the soft cushion material into a mold of a prescribed shape.

The hardness of the intermediate part 12 is preferably equal to or less than ½ of the hardness of the polishing part. More specifically, the hardness of the intermediate part is preferably 0.15 times to 0.5 times, and more preferably 0.2 times to 0.4 times, the hardness of the polishing part 13. Furthermore, the hardness of the polishing part is specifically preferably 10 to 30 in terms of Asker-C hardness.

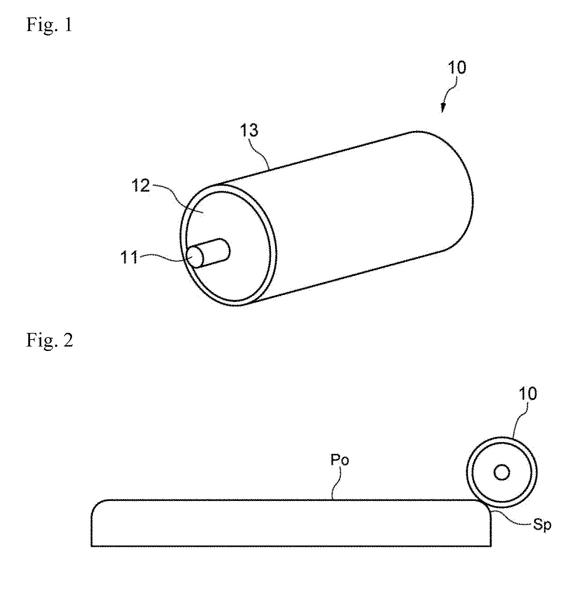

The polishing roll 10 is able to allow the polishing part 13 to make surface contact with a polished object by providing this cushioning intermediate part 12, thereby enabling the realization of both high removal amount and planarization. In the case of three-dimensionally polishing a polished object Po in particular, by providing the intermediate part 12 to be softer than the polishing part 13, the polishing part 13 can be made to follow, for example, spline curved surfaces Sp of the edges of the polishing object Po, thereby making it possible to realize high-speed and smooth three-dimensional polishing (see FIG. 2).

The polishing part 13 is a polishing sheet or polishing layer disposed on the outermost circumferential part of the polishing roll 10. The polishing pad used for CMP is typically, for example, a polyurethane foam-based material, nonwoven fabric-based material composed of a nonwoven fabric or nonwoven fabric impregnated with a resin, or a suede-based material (see Table 1) in order to ensure planarization and obtain retentive force of the slurry. These materials can be used for the polishing part 13 of the polishing roll 10 of the present embodiment. Among these, a composite base material obtained by impregnating a nonwoven fabric with a thermoplastic or thermosetting resin in the form of SUBA (a registered trademark) manufactured by Nitta Haas Inc. is preferable for use as a nonwoven fabric-based material.

TABLE 1

| | | | | |
|---|---|---|---|---|
| Product Name | IC1000 | MH-C15 | SUBA | POLITEX |

| | | | |
|---|---|---|---|
| Type | Polyurethane-based | Nonwoven | Suede-based |
| | | fabric-based | |

Furthermore, in a polishing process for polishing a polished object by processing into a prescribed shape, a polished object having a prescribed surface roughness can be obtained by repeating polishing a plurality of times. A suede-based polishing part 13 (such as POLITEX, trade name) is preferably used for the polishing part 13 for final finishing polishing of the polishing process. Other types of materials of the polishing part 13 described in Table 1 can also be used corresponding to the surface hardness required in the polishing process.

There are no particular limitations on the nonwoven fabric that forms the nonwoven fabric-based material of the polishing part 13 and is only required to be a nonwoven fabric produced from natural fibers (including modified fibers) or synthetic fibers and the like. For example, synthetic fibers such as polyester fiber, polyamide fiber, acrylic fiber or vinylon fiber, natural fibers such as cotton or hemp, and recycled cellulose fibers such as rayon or triacetate can be used. Two or more types of these fibers may be used. Among these, a synthetic fiber such as polyester fiber that does not exhibit water (moisture) absorption is used preferably for the polishing part 13 in consideration of prevention of swelling of the raw material fiber caused by slurry and the like as well as uniformity and volume productivity of the raw material fiber.

The nonwoven fabric-based material of the polishing part 13 may have a foamed resin material impregnated in the nonwoven fabric. Polyurethane, polyethylene, polypropylene, polyester, polyamide, polyvinyl chloride, polyacetal, polycarbonate, epoxy resin, ABS resin, AS resin, phenolic resin and resins having these as the main component thereof can be used for the foamed resin material. Two or more types of these resins may be used. Among these, polyurethane or a resin material having polyurethane for the main component thereof is suitable for the polishing part 13 from the viewpoint of control of closed air bubble diameter being comparatively easy.

In addition to the aforementioned nonwoven fabric-based materials, a polyurethane-based material or suede-based material and the like can be used for the material of the polishing part 13. In addition, the foamed body may be impregnated with resin. Polyurethane foam, for example, can be used for the material of the foamed body. Polyurethane foam, for example, can also be used as the material of a suede-based material. An acrylic-based resin, for example, can be used for the resin impregnated into these foamed bodies.

Moreover, the polishing part 13 is preferably impregnated with a ceria (cerium oxide) and/or silica (silicon oxide) abrasive. The reason for this is to be able to promote self-disintegration and prevent clogging by interposing inorganic substances among polyurethane crystals. In addition, another reason for this is to allow the abrasive to function as the abrasive immobilized on the polishing cloth or a portion of the separated abrasive by using the same material as the abrasive contained in the polishing slurry used during polishing.

The thickness (sheet thickness or layer thickness) of this polishing part 13 is such that the polishing part 13 is formed to be thinner than the intermediate part 12. In the case the polishing part 13 is in the form of a sheet (to be referred to as a “polishing sheet”), the polishing sheet is preferably wound around the outer peripheral surface of the intermediate part 12 with a suitable adhesive interposed there between in order to prevent lifting and delamination during polishing.

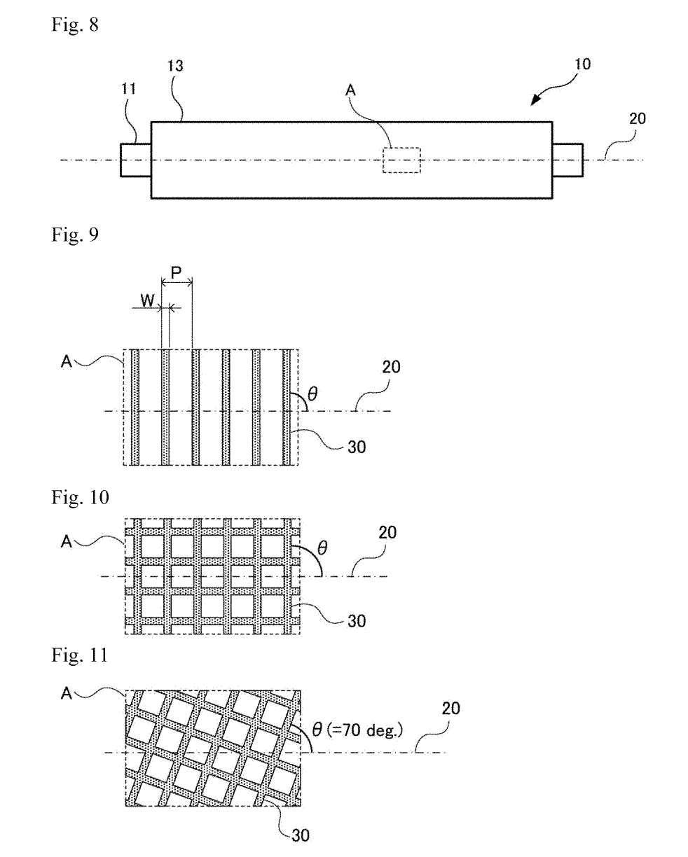

FIG. 8 is a side view exemplifying the polishing roll 10. The polishing part 13 of the polishing roll 10 can have grooves 30 in the surface thereof. FIGS. 9 to 11 exemplify schematic diagrams of the shape of the grooves 30 in the case of disposing the grooves 30 in the surface of the polishing roll 10. The shapes of the grooves 30 shown in FIGS. 9 to 11 are depicted by enlarging section A shown in FIG. 8. Furthermore, depictions of the grooves 30 are omitted in FIG. 8. The grooves 30 shown in FIGS. 9 to 11 can be disposed over the entire surface of the polishing part 13 shown in FIG. 8.

The retentive force of the slurry during polishing can be increased by the presence of the grooves 30 in the surface of the polishing part 13. In addition, detrimental effects on the surface of a polished object attributable to debris generated during polishing can be prevented as a result of the grooves 30 taking in that debris.

There are no particular limitations on the shape of the grooves 30 in the surface of the polishing part 13. The grooves 30 can be linear, curved or a combination thereof. In the case the grooves 30 are linear, a plurality of the grooves 30 can be arranged so as to mutually be parallel (parallel grooves) as shown in FIG. 9. In addition, in the case the grooves 30 are linear, two sets of a plurality of grooves can be arranged so as to be mutually perpendicular to obtain lattice-like grooves 30 as shown in FIGS. 10 and 11. In addition, arranging three sets of a plurality of parallel grooves so as to be at mutually different angles makes it possible to arrange the grooves such that the portions surrounded by the grooves 30 become triangular.

The grooves 30 in the surface of the polishing part 30 are preferably lattice-like grooves 30. The use of lattice-like grooves 30 makes it possible to increase the retentive force of the slurry during polishing. In addition, the use of lattice-like grooves 30 makes it possible to increase polishing speed since edges are present on the surface of the polishing part 13. Edges refer to portions in the vicinity of intersecting points between the sidewalls of the grooves 30 of the polishing part 13 and the surfaces of those portions where the grooves 30 are not present in the case the surface of the polishing part 13 has grooves.

In the present description, in the case the grooves 30 in the surface of the polishing part 13 include linear parallel grooves, the angle of the grooves 30 relative to the direction of the axis of rotation 20 of the polishing roll 10 is referred to as groove angle θ. For example, since the parallel grooves shown in FIG. 9 are perpendicular to the direction of the axis of rotation 20 of the polishing roll 10, the groove angle θ is 90 degrees. Groove angle θ can be represented with an angle of 0 degrees to 90 degrees. In the present embodiment, the groove angle θ is preferably greater than 0 degrees to 90 degrees, more preferably 45 degrees to less than 90 degrees, and even more preferably 60 degrees to 80 degrees. In the case the grooves 30 are in the form of a lattice, the grooves 30 are preferably arranged so that one of the two sets of plurality of intersecting parallel grooves is at the aforementioned angle. For example, in the example shown in FIG. 11, the grooves 30 are lattice grooves having parallel grooves having a groove angle θ of 70 degrees. The polishing speed of a polishing object can be increased as a result of the groove angle θ being a prescribed angle. In addition, as a result of the groove angle θ being a prescribed angle, force applied to the edges of the grooves 30 can be dispersed and deterioration of the polishing part 13 can be suppressed. As a result, the service life of the polishing roll 10 can be prolonged.

FIG. 9 indicates a pitch P and width W of the grooves 30 in the surface of the polishing part 13. The pitch P of the grooves 30 is equivalent to the length obtained by adding the length of the portion where the groove 30 is not present to the width W of the groove 30. In order to effectively increase slurry retentive force and polishing speed during polishing, the width W of the grooves 30 is preferably 0.2 mm to 5 mm and more preferably 0.5 mm to 3 mm. In addition, the pitch P of the grooves 30 is preferably 1 mm to 20 mm and more preferably 2 mm to 15 mm. In addition, the depth of the grooves 30 is preferably 0.2 mm to 2 mm and more preferably 0.4 mm to 1 mm. FIG. 9 exemplifies one set of parallel grooves. Even in the case of the lattice grooves shown in FIGS. 10 and 11, by making the two sets of plurality of intersecting grooves to be within the range of respectively similar values of pitch P, width W and depth, slurry retentive force and polishing speed during polishing can be effectively increased.

The polishing sheet 13 is wound around the outer peripheral surface of the intermediate part 12 and adhered thereto. In one embodiment as shown in FIG. 3, both mutually joining ends of the polishing sheet 13 are stitched together. In this case, the polishing surface on the front surface is preferably flat by making the seam allowance cloth (fabric) f of the stitched portion to be on the inside. According to this structure, delamination of the polishing sheet 13 can be effectively prevented since the cross-section of the polishing roll can be made to be as close to a true circle as possible.

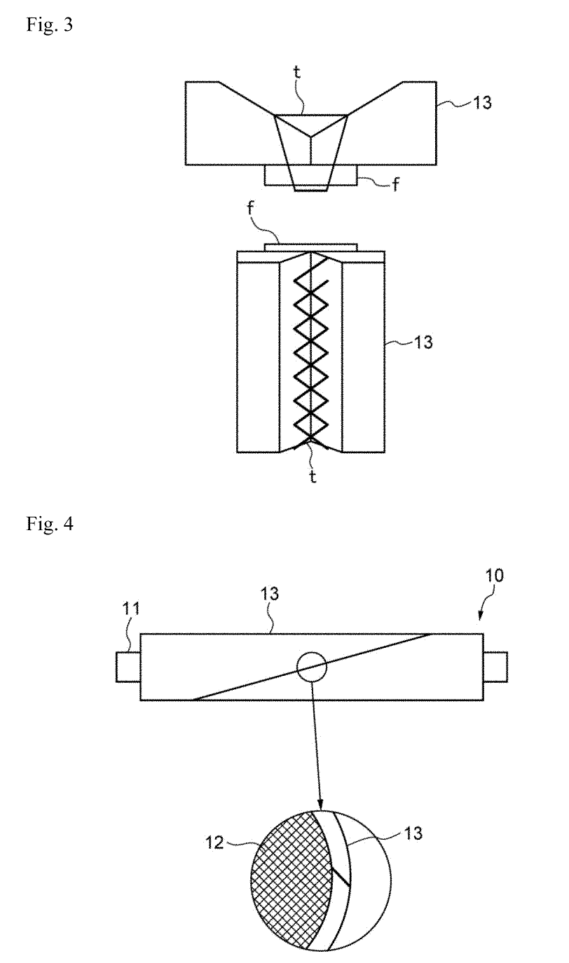

In another embodiment in which the polishing sheet 13 is wound around a roll of the intermediate part 12, both mutually joining ends of the polishing sheet 13 (also referred to as “junctions”) are preferably precut at an angle so as to form a line on an incline relative to the circumferential direction of the polishing roll 10 as shown in FIG. 4. Since the junctions of the rotating polishing sheet 13 move by intersecting relative to the advancing direction (circumferential direction) of polishing, cyclical undulation of the surface of the polished object can be eliminated to a certain degree. Moreover, as indicated by the enlarged cross-section taken from the circle shown in FIG. 4, the seal allowance (abutting surfaces) of both mutually joining edges of the polishing sheet 13 is preferably tapered. Increasing the surface area over which both ends of the polishing sheet 13 are adhered makes it possible to more effectively prevent delamination resulting from the junctions serving as the starting point of that delamination during polishing.

The following method can be used to make the junctions form a line inclined relative to the circumferential direction of the polishing roll 10 in the manner of the polishing roll 10 shown in FIG. 4.

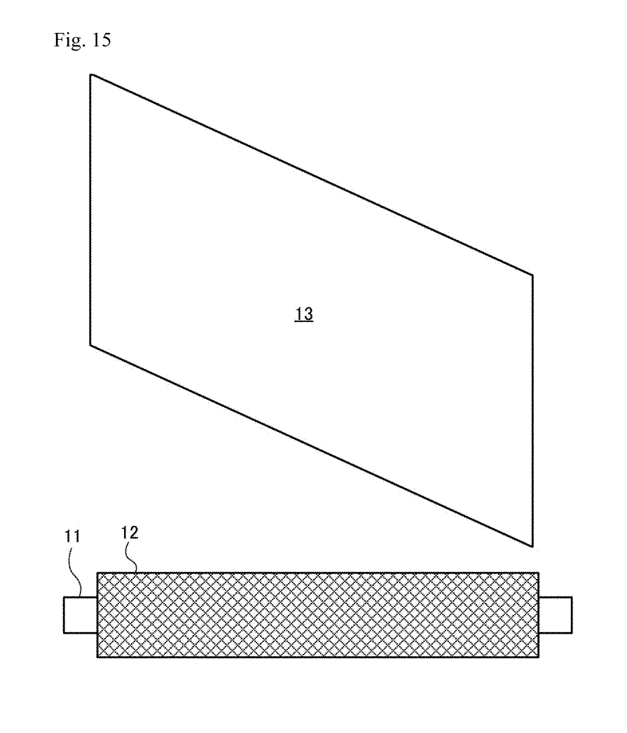

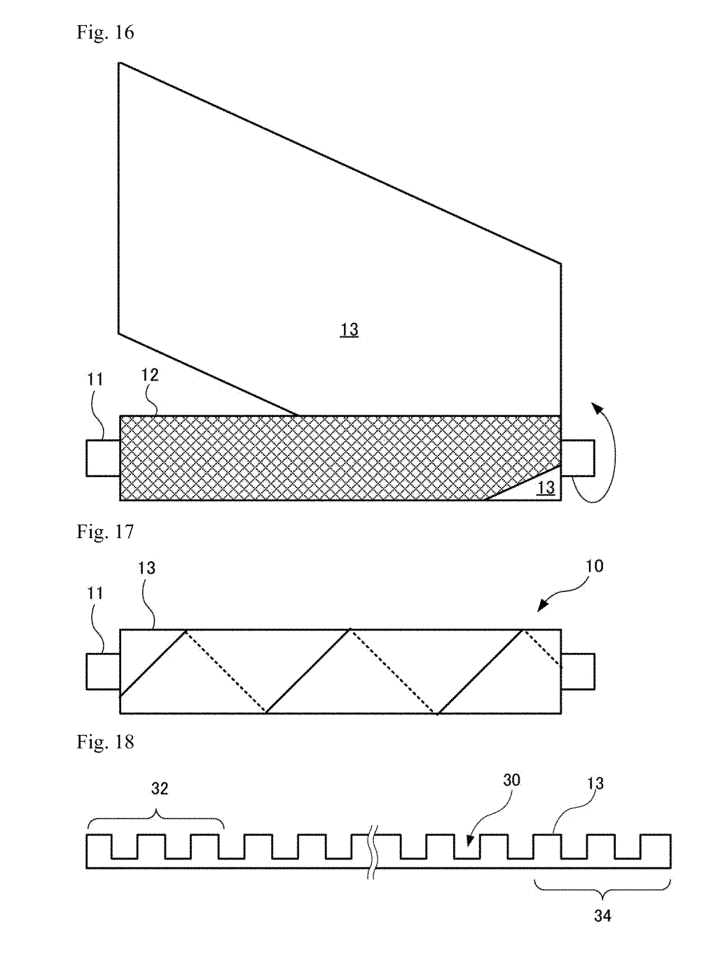

Namely, the polishing sheet 13 in the prescribed shape of a parallelogram is first prepared as shown in FIG. 15. Next, as shown in FIG. 16, the polishing sheet in the prescribed shape of a parallelogram is wound around the roll of the intermediate part 12. As a result, the polishing roll 10 shown in FIG. 4 can be obtained.

Furthermore, the polishing roll 10 having the polishing sheet 13 wound thereon as shown in FIG. 17 can be obtained by using a band-shaped polishing sheet 13. The polishing sheet 13 as shown in FIG. 17 can be wound around the roll of the intermediate part 12 in the same manner as wrapping adhesive tape around the handle of a tennis racket. In the example shown in FIG. 17, handling is superior since all that is required is to prepare the polishing roll 10 wound with a band-shaped polishing sheet 13 when producing the polishing roll 10.

The junctions of the polishing sheet 13 having the grooves 30 can be formed in the manner described below.

First, the polishing sheet 13 having the prescribed grooves 30 is prepared as shown in FIG. 18. Furthermore, one edge of the polishing sheet 13 is referred to as first edge 32 while the other edge is referred to as second edge 34.

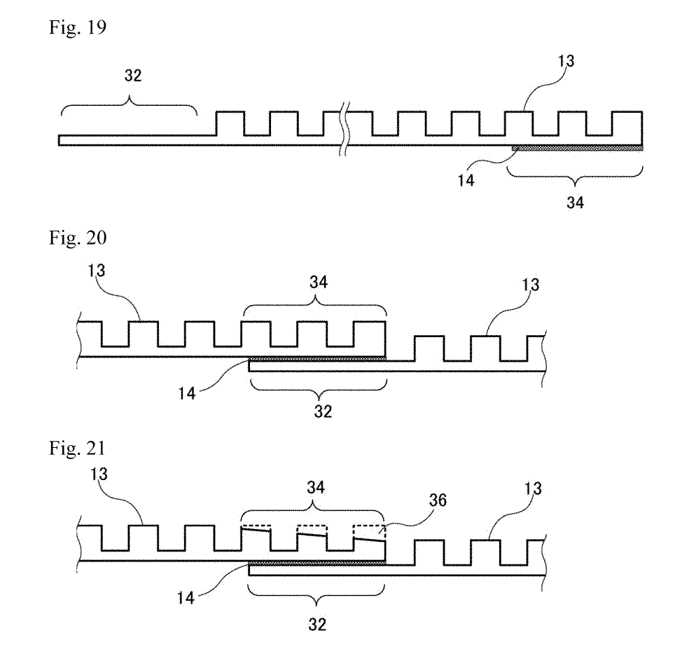

As shown in FIG. 19, the surface of the first edge 32 of the polishing sheet 13 is first machined or polished so that the grooves 30 of the first edge 32 do not remain. An adhesive is disposed on the back side of the other edge 34. An adhesive such as double-sided tape can be used for the adhesive. Furthermore, the machined or polished depth of the surface of the first edge 32 can be suitably adjusted. Namely, shallow grooves 30 can be allowed to remain on the surface of the first edge 32 as necessary. Alternatively, the surface of the first edge 32 can be machined or polished to be deeper than the depth of the grooves 30.

As shown in FIG. 20, the machined or polished surface of the first edge 32 is aligned with and attached to the back side of the second edge 34. The junction of the polishing sheet 13 having the grooves 30 can be formed in this manner.

Furthermore, as shown in FIG. 21, machined parts 36 can be removed by machining or polishing the surfaces of the second edge 34 as necessary. As a result, a junction can be formed that has a smooth surface.

In order to ensure reliable joining of the polishing sheet 13 at the junctions thereof, the length (width) of the junctions is preferably 2 mm to 20 mm, more preferably 5 mm to 15 mm and even more preferably 8 mm to 12 mm.

According to this type of polishing roll 10, a high removal amount can be achieved during polishing of a hard material such as sapphire glass. In addition, the polishing roll 10 is able to realize three-dimensional polishing in the manner of round cut polishing that follows not only the planarity of the upper surface and sides of a polished object, but also arbitrary spline surfaces in the edges thereof.

### EXAMPLES

### Example 1

The specifications of the polishing sheets and intermediate parts of polishing rolls used in polishing tests of Examples 1-1, 1-2 and 1-3 (to be collectively referred to as “Example 1”) are shown below. Furthermore, the conditions and polishing speeds (μm/min) of the polishing tests used in Example 1 are shown in Table 2.
Polishing roll:
   Diameter: 50 mm
   Length: 260 mm
Polishing sheet:
   Material: Polyurethane resin-impregnated nonwoven fabric
      (trade name: SUBA400)
   Hardness: Asker-C 60
   Thickness: 1.27 mm
   Basis weight: 3.8×10⁻⁴ g/mm² (bulk density: 3.0×10⁻⁴ g/mm³)
   Compressibility: 8.6%
   Groove shape: (No grooves)
Intermediate part (cushion material):
   Material: Polyurethane foam
   Hardness: Asker-C 34
   Density: 0.47 g/cm³
   Compressive deformation: 7.38 mm/kg·cm²

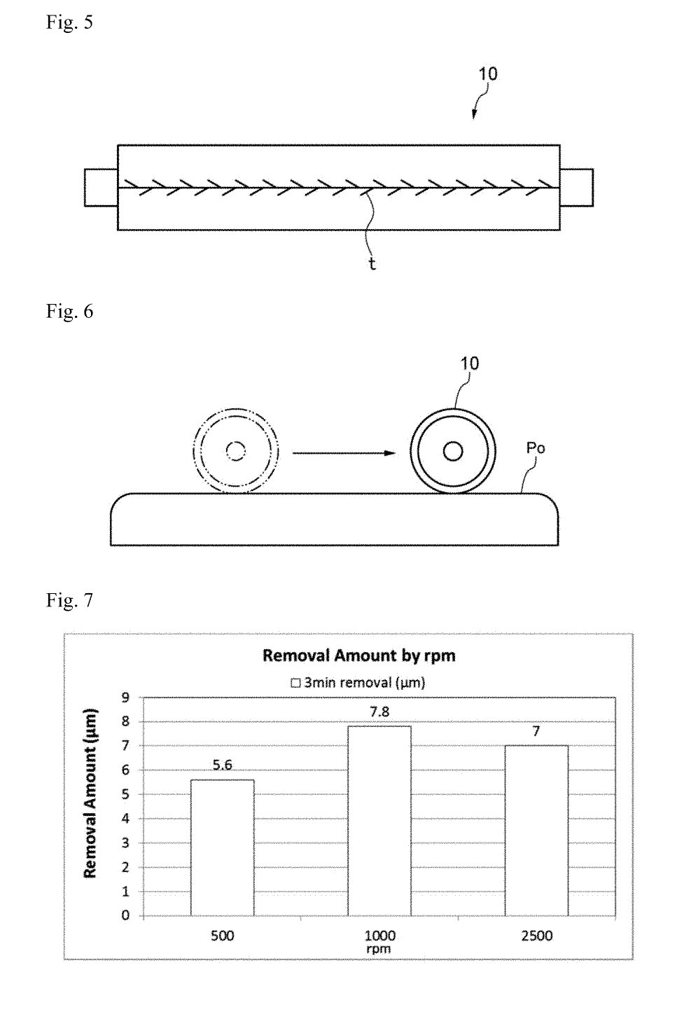

A side view of the polishing roll 10 is shown in FIG. 5. The polishing sheet was first stitched loosely in cylindrical shape followed by inserting polyurethane foam having an adhesive applied to the outer peripheral surface thereof (intermediate part) into the cylindrical polishing sheet. Subsequently, the polishing sheet and polyurethane foam were adhered by tightening the thread t of the stitched part.

The polishing roll 10 was rotated to carry out surface polishing while using sapphire glass for the polished object Po and supplying slurry containing an abrasive (cerium dioxide) at 7% by weight (see FIG. 6).

FIG. 7 indicates the results for removal amount in the case of the rotating speeds of the polishing rolls of Example 1 being 500 rpm, 1000 rpm and 2500 rpm. Polishing was carried out for 3 minutes at each rotating speed. In addition, Table 2 indicates the results for polishing speed when using the polishing rolls of Example 1. In Example 1, a high removal amount (polishing speed) of 5.6 μm or more was confirmed when polishing for 3 minutes at all rotating speeds.

### Example 2

Table 3 indicates the specifications, test conditions and polishing speeds (μm/min) of the polishing sheet 13 and the intermediate part 12 of polishing rolls 10 used in polishing tests of Examples 2-1 and 2-2 (to be collectively referred to as “Example 2”).

The core part 11 of the polishing rolls 10 of Example 2 (Examples 2-1 and 2-2) is composed of the metal shaft part 11a and the hollow cylindrical part 11b made of polyvinyl chloride. The key groove 43 is provided in the hollow cylindrical part 11b and engages with the key 42 attached to the shaft body 41 of the metal shaft part 11a. The key 42 is removable since it is screwed to the metal shaft part 11a. Core parts 11 of the same specifications as Example 2 were used in the case of Examples 3 and 4.

The intermediate parts 12 of Example 2 were produced by filling prescribed polyurethane foam into a mold of a prescribed shape. In addition, since the hollow cylindrical part 11b was also arranged when filling the polyurethane foam, the hollow cylindrical part 11b is in an adhered state to the intermediate part 12. Alternatively, after having filled polyurethane foam provided with a hollow space, an adhesive was applied to the hollow cylindrical part 11b resulting in a state in which it is inserted into the hollow space of the polyurethane foam. This applies similarly to the intermediate parts 12 of Examples 3 and 4.

After having formed the intermediate part 12, the metal shaft part 11a was inserted into the hollow cylindrical part 11b of the intermediate part 12 followed by attaching the key 42 to the shaft body 41 to obtain a roll composed of the intermediate part 12 and the core part 11.

Next, the polishing sheet 13 of a prescribed shape was prepared. A prescribed shape refers to a shape capable of covering the entire surface of the intermediate part 12 in consideration of the junctions of the polishing sheet 13. The prescribed sheet can be, for example, a parallelogram having prescribed dimensions as shown in FIG. 15.

The polishing sheet 13 of Example 2-1 does not have the grooves 30. On the other hand, the polishing sheet 13 of Example 2-2 has the grooves 30 (parallel grooves). As shown in FIG. 9, the shape of the grooves 30 of the polishing sheet 13 of Example 2-2 is such that they are equally spaced, linear parallel grooves 30. In addition, the groove angle θ is 90 degrees. Table 3 indicates the groove pitch P, groove width W and groove depth of Example 2-2.

Next, an adhesive was applied to the surface of the intermediate part 12. In addition, an adhesive was also applied to the adhering surface (back side) of the polishing sheet 13. Bond G17 Fast-Drying Adhesive (Konishi Co., Ltd.) was used for the adhesive. Subsequently, the adhesive was allowed to air-dry for 5 minutes. After the adhesive had dried, the polishing sheet 13 was wound around and adhered to the roll having the intermediate part 12 having the adhesive on the surface thereof.

The junctions of the polishing sheet 13 having the grooves 30 were formed by overlapping one edge of the adhesive sheet 13 with the other edge and attaching thereto by adhering with adhesive. At this time, as shown in FIG. 18, the thickness of the surface of one edge of the polishing sheet 13 in the form of the first edge 32 was reduced by machining. In addition, after having attached the junctions, the junctions were planarized by machining the surface of the other edge in the form of the second edge 34. Furthermore, the length (width) of the junctions was 10 mm. The polishing rolls 10 of Example 2 (Examples 2-1 and 2-2) were produced according to the aforementioned method.

Next, the polishing roll 10 was rotated to carry out surface polishing of a polished object while using sapphire glass for the polished object Po and supplying slurry containing an abrasive (cerium dioxide) at 20% by weight (see FIG. 6).

Table 3 indicates the results for polishing speed of the polishing rolls of Examples 2-1 and 2-2. In Example 2, both Example 2-1 and Example 2-2 demonstrated superior polishing speeds of 2.1 μm/min or more. In Example 2, Example 2-2 using the polishing sheet 30 having the grooves 30 in the surface thereof demonstrated a higher polishing speed in comparison with Example 2-1 using the polishing sheet 13 not having the grooves 30 in the surface thereof.

### Example 3

Table 4 indicates the specifications, test conditions and polishing speeds (μm/min) of the polishing sheet 13 and the intermediate part 12 of polishing rolls 10 used in polishing tests of Examples 3-1 to 3-3 (to be collectively referred to as “Example 3”).

As shown in Table 4, the polishing sheets 13 of Example 3 (Examples 3-1 to 3-3) have lattice grooves of a prescribed shape. The groove angles θ in Examples 3-1, 3-2 and 3-3 were 45 degrees, 70 degrees and 90 degrees, respectively. Furthermore, the groove angle θ in this case refers to the angle of the grooves 30 relative to the axis of rotation 20 of the polishing roll 10, and the groove angle θ is within a range of 45 degrees to 90 degrees of the set of parallel grooves among the two sets of parallel grooves intersecting in the manner of a lattice (see FIG. 11).

The grooves of Examples 3-1 and 3-3 were formed by machining processing. The grooves of Example 3-2 were formed by heat embossing (embossing processing). The polishing rolls 10 were produced in the same manner as Example 2 with the exception of the above, and surface polishing was carried out on a polished object Po using sapphire glass for the polished object Po.

Table 4 indicates the results for the polishing speeds of the polishing rolls 10 of Example 3. In Example 3, superior polishing speeds of 2.8 μm/min or more were demonstrated in each case. In Example 3, Example 3-2, which used the polishing sheet 13 having the grooves 30 having a groove angle θ of 70 degrees, demonstrated a high polishing speed (4.26 μm/min) On the basis of this result, a high polishing speed was suggested to be able to be obtained by making the groove angle θ to be roughly 70 degrees, and more specifically, 60 degrees to 80 degrees.

### Example 4

Table 5 indicates the specifications, test conditions and polishing speeds (μm/min) of the polishing sheet 13 and the intermediate part 12 of polishing rolls 10 used in polishing tests of Examples 4-1 to 4-4 (to be collectively referred to as “Example 4”).

As shown in Table 5, the hardness values (Asker-C) of the intermediate part 12 of the polishing rolls 10 of Examples 4-1 to 4-4 of Example 4 were each different, ranging from 10 to 34. The polishing rolls 10 were produced using the polishing sheet 13 not having grooves 30 in the same manner as Example 2-1 with the exception of the above, and surface polishing was carried out on a polished object Po using sapphire glass for the polished object Po.

Table 5 indicates the results for the polishing speeds of the polishing rolls of Example 4. In Example 4, superior polishing speeds of 1.3 μm/min or more were demonstrated in each example. In Example 4, in the case of using the polishing sheets 13 of Examples 4-1, 4-2 and 4-3, in which the hardness values (Asker-C hardness) of the intermediate part 12 ranged from 10 to 28, comparatively high polishing speeds (1.6 μm/min or more) were able to be obtained. In addition, in Example 4, particularly in the case of using the polishing sheet 13 of Example 4-2, in which the hardness of the intermediate part 12 was 20, an even higher polishing speed (2.13 μm/min) was able to be obtained. On the basis of these results, high polishing speed were suggested to be able to be obtained in cases in which the hardness of the intermediate part 12 ranged from 10 to 30, and preferably in the case the hardness was about 20. In addition, since the hardness (Asker-C) of the polishing sheet 13 is 60, it was suggested that the hardness of the intermediate part 12 preferably be 0.15 times to 0.5 times, and more preferably 0.2 times to 0.4 times, the hardness of the polishing part 13 in order to obtain high polishing speeds.

TABLE 2

| Exam- | Exam- | Exam- |
|---|---|---|
| ple | ple | ple |
| 1-1 | 1-2 | 1-3 |

| | | |
|---|---|---|
| Polishing | Diameter (mm) | 50 |
| roll | Length (mm) | 260 |
| Polishing | Material (trade name) | Polyurethane resin- |
| sheet | | impregnated nonwoven |
| | | fabric (SUBA400) |
| | Hardness (Asker-C) | 60 |
| | Thickness (mm) | 1.27 |
| | Basis weight (g/mm²) | 3.8 × 10⁻⁴ |
| | Compressibility (%) | 8.6 |
| | Grooves | Absent |
| | Attachment method | Stitching |
| Interme- | Material | Polyurethane foam |
| diate | Hardness (Asker-C) | 34 |
| part | Density (g/cm³) | 0.470 |
| | Compressive deformation | 0.9 |
| | (mm/kg · cm²) | |
| Core part | Inner core part | Metal shaft |
| | Outer core part | (None) |

| | | | |
|---|---|---|---|
| Polishing rotating speed (rpm) | 500 | 1000 | 2500 |

| | | |
|---|---|---|
| Slurry | Abrasive (cerium | 7 |
| | dioxide, content: | |
| | wt %) | |
| | Flow rate (ml/min) | 50 |

| | | | |
|---|---|---|---|
| Polishing speed (μm/min) | 1.87 | 2.60 | 2.33 |

TABLE 3

| | | Exam- | Exam- |
|---|---|---|---|
| | | ple | ple |
| | | 2-1 | 2-2 |
| Polishing | Diameter (mm) | 75 | |
| roll | Length (mm) | 260 | |
| Polishing | Material (trade name) | Polyurethane resin- | |
| sheet | | impregnated nonwoven | |
| | | fabric (SUBA400) | |
| | Hardness (Asker-C) | 60 | |
| | Thickness (mm) | 1.27 | |
| | Basis weight (g/mm²) | 3.8 × 10⁻⁴ | |
| | Compressibility (%) | 8.6 | |
| | Grooves | Absent | Present |
| | Groove width (mm) | — | 1 |
| | Groove pitch (mm) | — | 5 |
| | Groove depth (mm) | — | 0.7 |
| | Groove shape | — | Parallel grooves |
| | Groove processing method | — | Machining |
| | Groove angle θ (degrees) | — | 90 |

| | Attachment method | Adhesive, overlapping edges |
|---|---|---|
| Interme- | Material | Polyurethane foam |
| diate | Hardness (Asker-C) | 20 |
| part | Density (g/cm³) | 0.355 |
| | Compressive deformation | 3.4 |
| | (mm/kg · cm²) | |
| Core part | Inner core part | Metal shaft |
| | Outer core part | Polyvinyl chloride |
| Polishing rotating speed (rpm) | | 2500 |
| Slurry | Abrasive (cerium | 20 |
| | dioxide, content: | |
| | wt %) | |
| | Flow rate (ml/min) | 50 |

| | | |
|---|---|---|
| Polishing speed (μm/min) | 2.13 | 2.63 |

TABLE 4

| | | Exam- | Exam- | Exam- |
|---|---|---|---|---|
| | | ple | ple | ple |
| | | 3-1 | 3-2 | 3-3 |
| Polishing | Diameter (mm) | 70 | 69.43 | 70 |
| roll | Length (mm) | 260 | | |
| Polishing | Material (trade name) | Polyurethane resin- | | |
| sheet | | impregnated nonwoven | | |
| | | fabric (SUBA400) | | |
| | Hardness (Asker-C) | 60 | | |
| | Thickness (mm) | 1.27 | 0.7 | 1.27 |
| | Basis weight (g/mm²) | 3.8 × 10⁻⁴ | | |
| | Compressibility (%) | 8.6 | | |
| | Grooves | Present | Present | Present |
| | Groove width (mm) | 2 | 1 | 2 |
| | Groove pitch (mm) | 15 | 3 | 15 |
| | Groove depth (mm) | 0.7 | 0.5 | 0.7 |
| | Groove shape | Lattice | Lattice | Lattice |
| | | grooves | grooves | grooves |
| | Groove processing | Machining | Heat | Machining |
| | method | | embossing | |
| | Groove angle θ | 45 | 70 | 90 |
| | (degrees) | | | |

| | Attachment method | Adhesive, overlapping edges |
|---|---|---|
| Interme- | Material | Polyurethane foam |
| diate | Hardness (Asker-C) | 20 |
| part | Density (g/cm³) | 0.355 |
| | Compressive deformation | 3.4 |
| | (mm/kg · cm²) | |
| Core part | Inner core part | Metal shaft |
| | Outer core part | Polyvinyl chloride |
| Polishing rotating speed (rpm) | | 2500 |
| Slurry | Abrasive (cerium | 20 |
| | dioxide, content: | |
| | wt %) | |
| | Flow rate (ml/min) | 50 |

| | | | |
|---|---|---|---|
| Polishing speed (μm/min) | 2.86 | 4.26 | 3.12 |

TABLE 5

| | | Exam- | Exam- | Exam- | Exam- |
|---|---|---|---|---|---|
| | | ple | ple | ple | ple |
| | | 4-1 | 4-2 | 4-3 | 4-4 |
| Polishing | Diameter (mm) | 75 | | | |
| roll | Length (mm) | 260 | | | |
| Polishing | Material (trade | Polyurethane resin- | | | |
| sheet | name) | impregnated nonwoven | | | |
| | | fabric (SUBA400) | | | |
| | Hardness (Asker-C) | 60 | | | |
| | Thickness (mm) | 1.27 | | | |
| | Basis weight | 3.8 × 10⁻⁴ | | | |
| | (g/mm²) | | | | |
| | Compressibility (%) | 8.6 | | | |
| | Grooves | Absent | | | |
| | Attachment method | Adhesive, overlapping edges | | | |
| Interme- | Material | Polyurethane foam | | | |
| diate | Hardness (Asker-C) | 10 | 20 | 28 | 34 |
| part | Density (g/cm³) | 0.163 | 0.355 | 0.450 | 0.470 |
| | Compressive | 7.4 | 3.4 | 2.0 | 0.9 |
| | deformation | | | | |
| | (mm/kg · cm²) | | | | |

| Core part | Inner core part | Metal shaft |
|---|---|---|
| | Outer core part | Polyvinyl chloride |
| Polishing rotating speed (rpm) | | 2500 |
| Slurry | Abrasive (cerium | 20 |
| | dioxide, content: | |
| | wt %) | |
| | Flow rate (ml/min) | 50 |

| | | | | |
|---|---|---|---|---|
| Polishing speed (μm/min) | 1.61 | 2.13 | 1.60 | 1.38 |

### BRIEF DESCRIPTION OF REFERENCE SYMBOLS

10 Polishing roll
11 Core part
11a Metal shaft part
11b Hollow cylindrical part
12 Intermediate part
13 Polishing part (polishing sheet)
14 Adhesive
20 Polishing roll axis of rotation
30 Groove
32 First edge of polishing sheet
34 Second edge of polishing sheet
36 Machined part
41 Shaft body
42 Key
43 Key groove

1. A cylindrical polishing roll capable of rotating about a central axis, wherein
the polishing roll comprises a core part serving as a central axis to which torque is applied, an intermediate part having a cross-section concentric with the core part, and a polishing part disposed on the outer peripheral surface of the intermediate part, and
the intermediate part is made of a cushion material that is softer than the polishing part.

2. The polishing roll according to claim 1, wherein the polishing part is a nonwoven fabric or a nonwoven fabric impregnated with a resin.

3. The polishing roll according to claim 1, wherein the polishing part is a foamed body or foamed body impregnated with a resin.

4. The polishing roll according to according to claim 2, wherein the resin contains polyurethane.

5. The polishing roll according to claim 1, wherein the polishing part is impregnated with a ceria (cerium oxide) and/or silica (silicon oxide) abrasive.

6. The polishing roll according to claim 1, wherein the polishing part has grooves in the surface thereof.

7. The polishing roll according to claim 6, wherein the grooves include linear parallel grooves and the angle of the grooves relative to the direction of the axis of rotation of the polishing roll is 0 degrees to 90 degrees.

8. The polishing roll according to claim 6, wherein the grooves are lattice-like grooves.

9. The polishing roll according to claim 1, wherein the intermediate part is composed of a foamed body.

10. The polishing roll according to claim 9, wherein the foamed body is sponge-like polyurethane foam.

11. The polishing roll according to claim 1, wherein the intermediate part is composed of an elastomer.

12. The polishing roll according to claim 1, wherein the polishing part is a polishing sheet adhered to the outer peripheral surface of the intermediate part.

13. The polishing roll according to claim 12, wherein the polishing sheet has the shape of a parallelogram.

14. The polishing roll according to claim 12, wherein both mutually joining ends of the polishing sheet wound around the intermediate part are stitched.

15. The polishing roll according to claim 12, wherein both mutually joined ends of the polishing sheet wound around the intermediate part form a line on an incline relative to the circumferential direction.

16. The polishing roll according to claim 12, wherein the seam allowance (abutting surfaces) of both mutually joining edges of the polishing sheet wound around the intermediate part is tapered.

17. The polishing roll according to claim 1, wherein the core part comprises:
a metal shaft part serving as the central axis, and
a hollow cylindrical part in the shape of a hollow cylinder for disposing the metal shaft part in the interior thereof, the hollow cylindrical part having a structure enabling removal from the metal shaft part.

18. The polishing roll according to claim 17, wherein the hollow cylindrical part has a structure adhered to the intermediate part.
